(19) United States
(12) Patent Application Publication
(10) Pub. No.: US 2014/0255757 A1
(43) Pub. Date: Sep. 11, 2014

(54) RECHARGEABLE BATTERY

(71) Applicant: Samsung SDI Co., Ltd., Yongin-si (KR)

(72) Inventors: Seon-Yeong KANG, Yongin-si (KR); Kang-Kook JUNG, Yongin-si (KR); Hyung-Dong LEE, Yongin-si (KR)

(73) Assignee: Samsung SDI Co., Ltd., Yongin-si (KR)

(21) Appl. No.: 14/088,088

(22) Filed: Nov. 22, 2013

Related U.S. Application Data
(60) Provisional application No. 61/774,482, filed on Mar. 7, 2013.

(51) Int. Cl. H01M 2/10

(52) U.S. Cl. CPC H01M 2/1094
USPC 429/149

(57) ABSTRACT

An example embodiment is to provide a rechargeable battery capable of including a plurality of electrode assemblies in one pouch while reducing the overall size. According to an example embodiment, a rechargeable battery may include at least one pair of electrode assemblies and a pouch forming one pair of battery cells by accommodating the electrode assemblies and sealing the outside of each electrode assembly, wherein the pouch includes a folding portion formed by folding a sealing portion between the one pair of battery cells.

### CROSS-REFERENCE TO RELATED APPLICATIONS

This application claims the benefit of U.S. Provisional Application No. 61/774,482, filed Mar. 7, 2013, which is hereby incorporated by reference in its entirety.

### BACKGROUND

1. Field

The disclosure relates to a rechargeable battery including a plurality of electrode assemblies in one pouch.

2. Description of the Related Art

A rechargeable battery can be recharged and discharged repeatedly, unlike a primary battery. A small-capacity rechargeable battery is used for small portable electronic devices such as a mobile phone, a notebook computer, a camcorder, and the like. A large capacity rechargeable battery is used for an electric vehicle or hybrid electric vehicle that requires high power/large capacity.

Demand for the pouch type rechargeable battery is increasing because the thickness is small, the deformation is easy and the manufacturing cost is cheap, for example. Also, a pouch type rechargeable battery can accommodate a plurality of electrode assemblies in one pouch. This pouch type rechargeable battery shares sealing surfaces of adjacent electrode assemblies to reduce the number of sealing surfaces per the electrode assembly.

However, the pouch type rechargeable battery connects the electrode assembly in a simple straight-line direction, or in a plane direction (x, y), so the overall size is increased.

The above information disclosed in this Background section is only for enhancement of understanding of the background of the embodiments and therefore it may contain information that does not form the prior art that is already known in this country to a person of ordinary skill in the art.

### SUMMARY

An example embodiment is to provide a rechargeable battery capable of including a plurality of electrode assemblies in one pouch while reducing the overall size.

According to an example embodiment, a rechargeable battery may include at least one pair of electrode assemblies and a pouch forming one pair of battery cells by accommodating the electrode assemblies and sealing the outside of each electrode assembly, wherein the pouch includes a folding portion formed by folding a sealing portion between the one pair of battery cells.

The pouch may include a first sheet to accommodate the electrode assembly and, a second sheet sealed on the first sheet to cover the electrode assembly, wherein the first sheet may be a single unit corresponding to at least one pair of electrode assemblies.

The folding portion may be formed with an end portion of the second sheet attached to both sides of a connection portion of the first sheet disposed between the one pair of battery cells.

The one pair of electrode assemblies include the first electrode assembly and the second electrode assembly, which are adjoining, and the first sheet may include a first accommodating portion opened from one side in the axis direction to accommodate the first electrode assembly and a second accommodating portion opened from the opposite side in the axis direction to accommodate the second electrode assembly.

The second sheet may include a first portion that covers the first electrode assembly to be sealed on the first sheet corresponding to the first accommodating portion and a second portion that covers the second electrode assembly to be sealed on the first sheet corresponding to the second accommodating portion.

The folding portion may be formed with an end portion of the first portion of the second sheet and an end portion of the second portion of the second sheet, which are attached on the both sides of the connection portion of the first sheet disposed between the one pair of battery cells.

The one pair of electrode assemblies include the first electrode assembly and the second electrode assembly, which are adjoining, and, the pouch may include the first sheet that accommodates the first electrode assembly and covers the second electrode assembly, and the second sheet sealed on the first sheet that accommodates the second electrode assembly and covers the first electrode assembly.

The first sheet may include a first accommodating portion opened from one side in the axis direction to accommodate the first electrode assembly and a first cover portion to cover the second electrode assembly, and the second sheet may include a second accommodating portion opened from the opposite side in the axis direction to accommodate the second electrode assembly and a second cover portion to cover the first electrode assembly.

The folding portion may be formed with the connection portion of the first sheet and the connection portion of the second sheet, which are disposed between the one pair of battery cells.

The one pair of electrode assemblies include the first electrode assembly and the second electrode assembly, which are adjoining, and the first sheet may include a first accommodating portion opened from one side in the axis direction to accommodate the first electrode assembly and a second accommodating portion opened in the same direction to accommodate the second electrode assembly.

The second sheet may include a first portion that covers the first electrode assembly to be sealed on the first sheet corresponding to the first accommodating portion and a second portion that covers the second electrode assembly to be sealed on the first sheet corresponding to the second accommodating portion.

The folding portion may be formed with an end portion of the first portion of the second sheet and an end portion of the second portion of the second sheet, which are attached on the both sides of the connection portion of the first sheet disposed between the one pair of battery cells.

The one pair of electrode assemblies include the first electrode assembly and the second electrode assembly, which are adjoining, and a lead tab connected to the first electrode assembly and a lead tab connected to the second electrode assembly may be drawn out from the each battery cell in the same direction, respectively.

The one pair of electrode assemblies include the first electrode assembly and the second electrode assembly, which are adjoining, and a lead tab connected to the first electrode assembly and a lead tab connected to the second electrode assembly may be drawn out from the each battery cell in the opposite direction from each other.

According to this example embodiment, in the pouch forming at least one pair of battery cells, since the folding portion is formed by folding the sealing portion between the battery cells, there is an effect of including a plurality of electrode assemblies in one pouch while reducing the overall size.

### BRIEF DESCRIPTION OF THE DRAWINGS

FIG. 1 is an exploded perspective view showing a rechargeable battery according to a first example embodiment.

FIG. 2 is a top plan view that assembles a rechargeable battery of FIG. 1.

FIG. 3 is a cross-sectional view taken along a line III-III of FIG. 2.

FIG. 4 is a cross-sectional view showing a state where a rechargeable battery of FIG. 3 is folded.

FIG. 5 is an exploded perspective view showing a rechargeable battery according to a second example embodiment.

FIG. 6 is a cross-sectional view taken along a line VI-VI of FIG. 5.

FIG. 7 is a cross-sectional view showing a state where a rechargeable battery of FIG. 6 is folded.

FIG. 8 is a cross-sectional view showing a rechargeable battery according to a third example embodiment.

FIG. 9 is a cross-sectional view showing a state where a rechargeable battery of FIG. 8 is folded.

FIG. 10 is a top plan view showing a rechargeable battery according to a fourth example embodiment.

### DETAILED DESCRIPTION OF THE PREFERRED EMBODIMENT

Hereinafter, the present embodiments will be described more fully with reference to the accompanying drawings, in which example embodiments are shown. As those skilled in the art would realize, the described embodiments may be modified in various different ways, all without departing from the spirit or scope of the present embodiments. The drawings and description are to be regarded as illustrative in nature and not restrictive. Like reference numerals designate like elements throughout the specification.

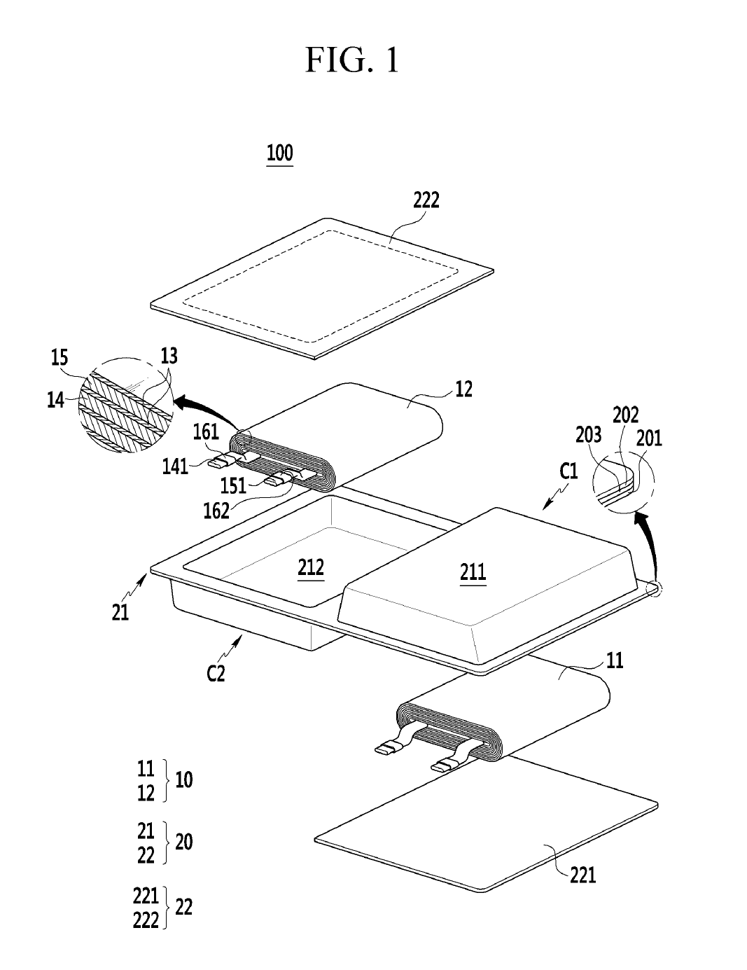

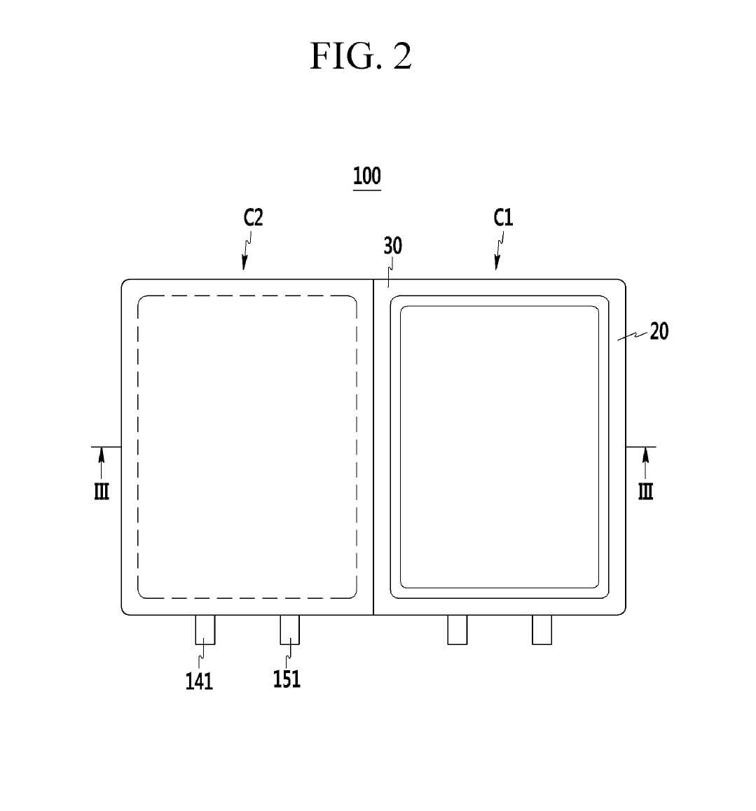

FIG. 1 is an exploded perspective view showing a rechargeable battery according to a first example embodiment, and FIG. 2 is a top plan view that assembles a rechargeable battery of FIG. 1. Referring to FIG. 1 and FIG. 2, in the first example embodiment, a rechargeable battery 100 has a pouch type that includes an electrode assembly 10 and a pouch 20 for accommodating the electrode assembly 10 and an electrolyte solution.

In the first example embodiment, the rechargeable battery 100 includes at least one pair of electrode assemblies 10 and, for convenience, the electrode assemblies 10 illustrates a first electrode assembly 11 and a second electrode assembly 12. The pouch 20 accommodates the one pair of first and second electrode assemblies 11 and 12 to form a sealing portion 30 to seal the outside of each of the first and second electrode assemblies 11 and 12.

The first and second electrode assemblies 11 and 12 are formed with the same structure for each other. For example, the second electrode assembly 12 is formed with a jelly roll type by disposing and winding a separator 13 between a positive electrode 14 and a negative electrode 15 so as to be charged and discharged. As an example, the separator 13 may be formed with a polymer film to pass a lithium ion.

The positive electrode 14 includes a coating portion applying an active material to a current collector of a metal thin film, and an uncoated portion set to an exposed current collector by not applying the active material. For example, the positive electrode 14 is formed with an aluminum thin film, and a positive electrode lead tab 141 is connected to the uncoated portion of the positive electrode 14.

The negative electrode 15 includes a coating portion applying an active material different from the active material of the positive electrode 14 to the current collector of the metal thin film, and an uncoated portion set to the exposed current collector by not applying the active material

For example, the negative electrode 15 is formed with a copper thin film, and a negative electrode lead tab 151 is separated from the positive electrode lead tab 141 and then connected to the uncoated portion of the negative electrode 15.

For example, the pouch 20 has an one side concavely formed and the other side flatly formed so as to wrap the outside of the electrode assembly 10, and then forms a sealing portion 30 by thermal bonding borders opposed to each other.

As the sealing portion 30 of the pouch 20 is integrally formed, the rechargeable battery 100 is formed connecting the one pair of battery cells C1 and C2. The sealing portion 30 partitions the first electrode assembly 11 and the second electrode assembly 12 so that the one pair of battery cells C1 and C2 may accommodate independently the electrolyte solution in each of the one pair of battery cells C1 and C2.

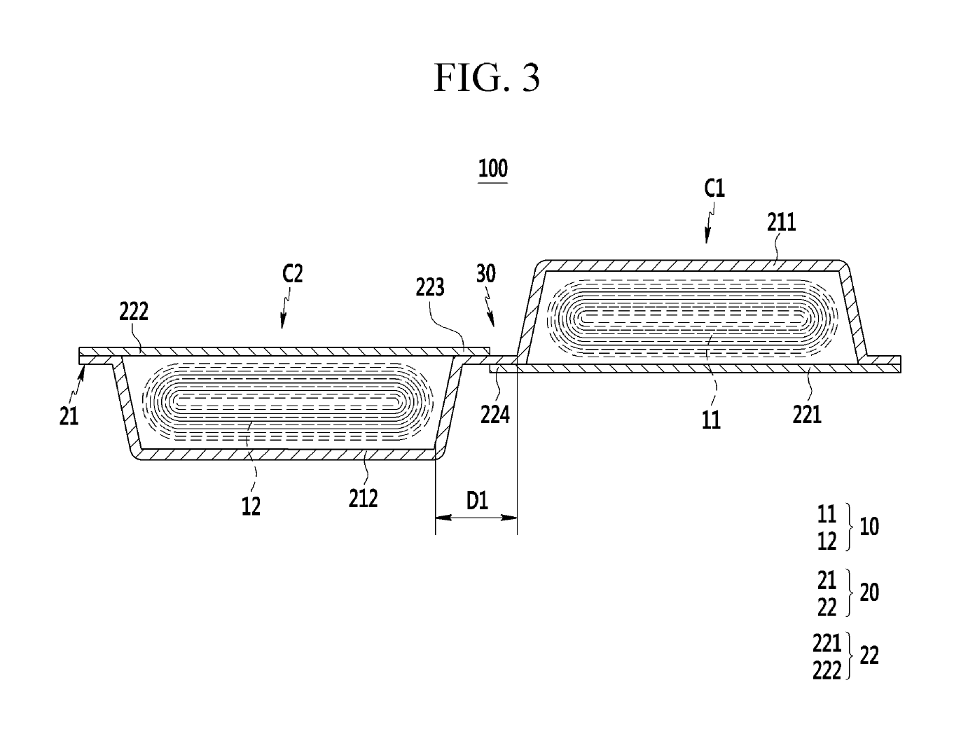

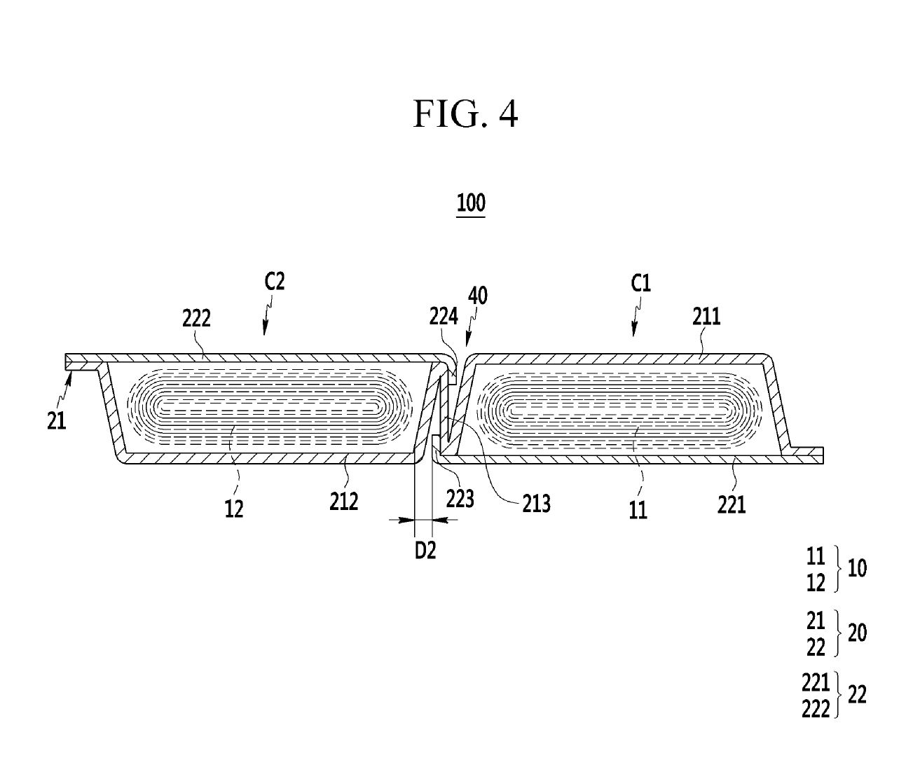

The sealing portion 30 includes a folding portion 40 folded between the one pair of battery cells C1 and C2. The folding portion 40 reduces an interval to connect the one pair of battery cells C1 and C2 connect so that the overall size of the rechargeable battery 100 can be reduced. The interval between the one pair of battery cells C1 and C2 can be short from a first interval (D1, see FIG. 3) before folding to a second interval (D2, see FIG. 4) after folding.

The pouch 20 includes the first sheet 21 to accommodate the electrode assembly 10, and the second sheet 22 that seals and covers the electrode assembly 10 by being heat-welded to the first sheet 21. In the first example embodiment, the first sheet 21 is formed integrally to be a single unit corresponding to the first electrode assembly 11 and the second electrode assembly 12.

For example, the first sheet 21 includes a first accommodating portion 211 opened from one side (lower side) in an axis direction (an upper and lower direction in FIG. 1) to accommodate the first electrode assembly 11 and a second accommodating portion 212 opened from the opposite side (upper side) in the axis direction to accommodate the second electrode assembly 12.

In this regard, the second sheet 22 includes a first portion 221 that covers the first electrode assembly 11 to be sealed by thermal bonding on the first sheet 21 corresponding to the first accommodating portion 211, and a second portion 222 that covers the second electrode assembly 12 to be sealed by thermal bonding on the first sheet 21 corresponding to the second accommodating portion 212.

The first sheet 21 accommodating a pair of electrode assemblies 11 and 12 is formed to be a single unit that is alternately arranged with the first and second accommodating portion 211 and 212 opened from the one axis direction to the lower side and upper side, and the second sheet 22 includes the first portion 221 and the second portion 222, each of which is formed in separate units. The second sheet 22 is disposed by corresponding to the first and second accommodating portion 211 and 212.

In addition, although not shown, when the number of the electrode assemblies 10 is increased up to two or more, the first sheet 21 has the number corresponding to the electrode assemblies 10 by alternately opening the first and second accommodating portion 211 and 212 in the lower and upper sides, and the second sheet 22 may be disposed to have the number corresponding to the number of the first and second accommodating portion 211 and 212. In this case, the first sheet 21 may be formed to be a single unit, and the second sheet 22 may be provided with a plurality of sheets.

The first and second sheet 21 and 22 that forms the pouch 20 may be formed with the same structure for each other. Thus, the first sheet 21 in FIG. 1 may be described as, for example, the pouch 20. The pouch 20 is formed with a multi-layered sheet structure, and includes a polymer sheet 201 that forms an inner surface and acts for insulation and thermal bonding, a PET (polyethyleneterephthalate) sheet that forms an outer surface and acts for protection, and nylon sheet or PET-nylon composite sheet 202.

In addition, the pouch 20 further includes a metal sheet 203 provided between the polymer sheet 201 and the PET-nylon composite sheet 202 to provide mechanical strength. As an example, the metal sheet 203 may be formed with an aluminum sheet.

FIG. 3 is a cross-sectional view taken along a line III-III of FIG. 2, and FIG. 4 is a cross-sectional view showing a state where a rechargeable battery of FIG. 3 is folded. Referring to FIG. 3 and FIG. 4, the sealing portion 30 and the folding portion 40 disposed between the one pair of battery cells C1 and C2 include a connection portion 213 of the first sheet 21, and an end portion of the second sheet 22 attached to both sides of the connection portion 213. The both sides of the connection portion 213 are disposed with end portions 223 and 224 of first portion and second portion of the second sheet 221 and 222, respectively.

Again, referring to FIGS. 1 and 2, the positive electrode lead tab 141 connected to the positive electrode 14 and the negative electrode lead tab 151 connected to the negative electrode 15 are drawn out in the same side of the first and second electrode assemblies 11 and 12. Since the positive electrode lead tab 141 and the negative electrode lead tab 151 are protruded out of the pouch 20 sealed by thermal bonding, the first and second electrode assemblies 11 and 12 may be electrically connected to the outside of the pouch 20.

The insulating members 161 and 162 electrically insulate the positive and negative electrode lead tabs 141 and 151 by coating the positive and negative electrode lead tabs 141 and 151 on the pouch 20 so that the insulating properties between the positive and negative electrode lead tabs 141 and 151 can be increased.

Hereinafter, the various example embodiments will be described. In example embodiments below, by comparison of the above-mentioned first example embodiment and example embodiments, the same configuration will be omitted, and the different configuration will be described.

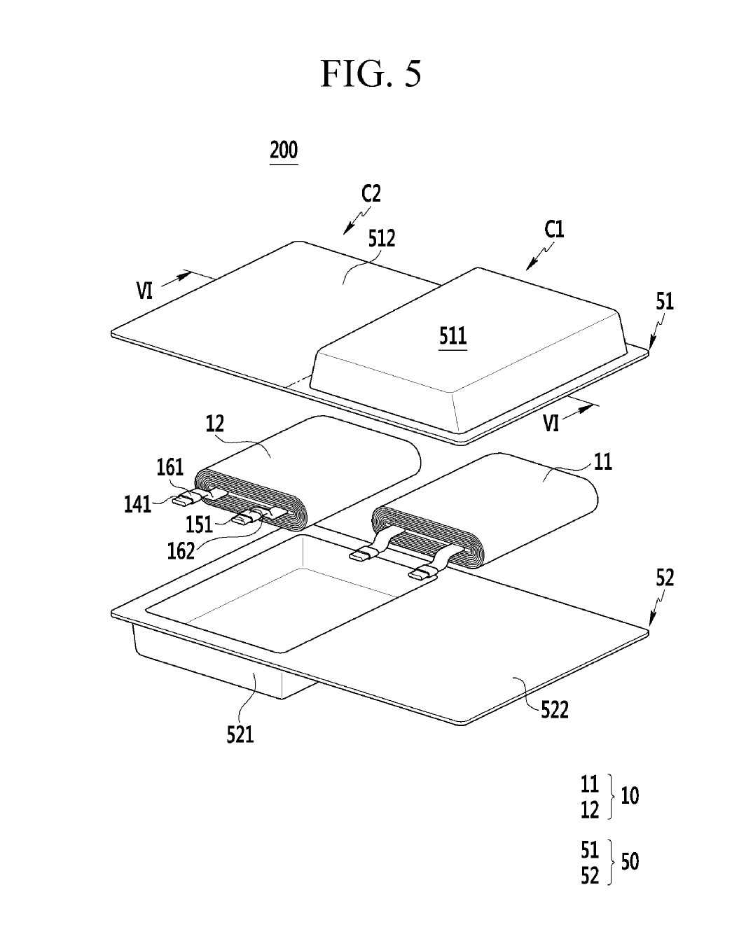

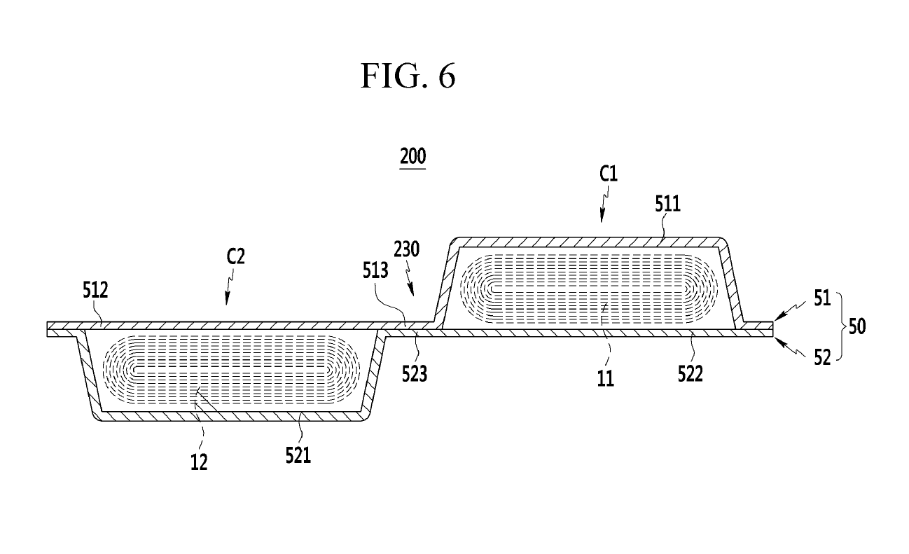

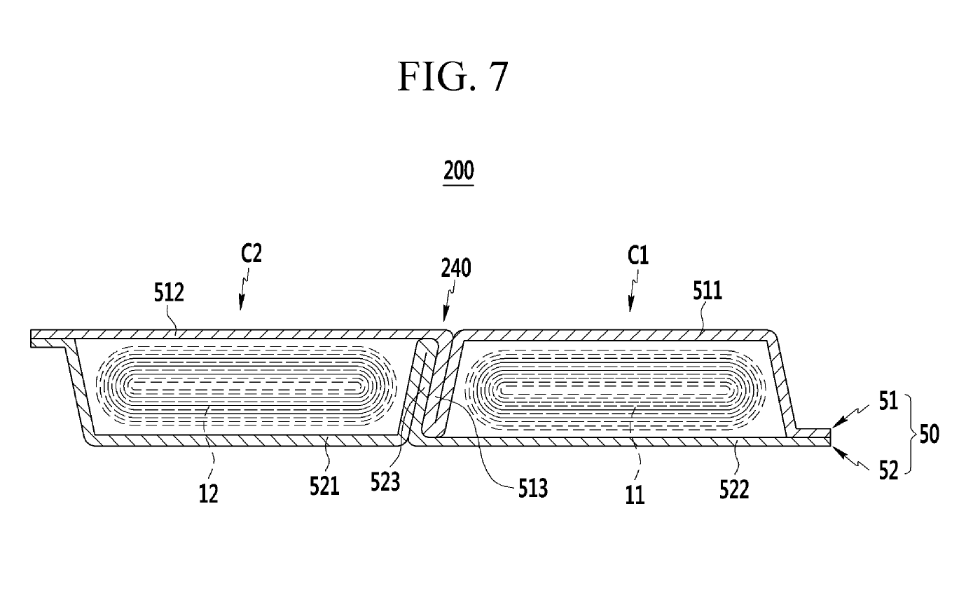

FIG. 5 is an exploded perspective view showing a rechargeable battery according to a second example embodiment, FIG. 6 is a cross-sectional view taken along a line VI-VI of FIG. 5, and FIG. 7 is a cross-sectional view showing a state where a rechargeable battery of FIG. 6 is folded.

Referring to FIGS. 5 to 7, in a rechargeable battery 200 according to the second example embodiment, a pouch 50 includes a first sheet 51 to accommodate a first electrode assembly 11 and to cover a second electrode assembly 12, and a second sheet 52 sealed by being heat-welded to the first sheet 51 to accommodate the second electrode assembly 12 and to cover the first electrode assembly 11.

The first sheet 51 includes a first accommodating portion 511 opened from one side (lower side) in an axis direction (an upper and lower direction in FIG. 5) to accommodate the first electrode assembly 11, and a first cover portion 512 to cover the second electrode assembly 12.

In this regard, the second sheet 52 includes a second accommodating portion 521 opened from the opposite side (upper side) in the axis direction to accommodate the second electrode assembly 12, and a second cover portion 522 to cover the first electrode assembly 11.

The first sheet 51 is alternately arranged with the first accommodating portion 511 opened from the one axis direction to the lower side and upper side, and a first cover portion 512 connected to the lower side of the first accommodating portion 511. The second sheet 52 is alternately arranged with the second accommodating portion 521 opened from the one axis direction to the upper side and upper side, and a second cover portion 522 connected to the upper side of the second accommodating portion 521. In this embodiment, the first sheet 51 and the second sheet 52 are respectively formed to be a single unit.

A sealing portion 230 and a folding portion 240 disposed between the one pair of battery cells C1 and C2 are formed by a connection portion 513 of the first sheet 51, and a connection portion 523 of the second sheet 52 attached to one side of the connection portion 513. The folding portion 240 can reliably implement a connection structure of the battery cells C1 and C2 by the connection portions 513 and 523 of the first and second sheets 51 and 52.

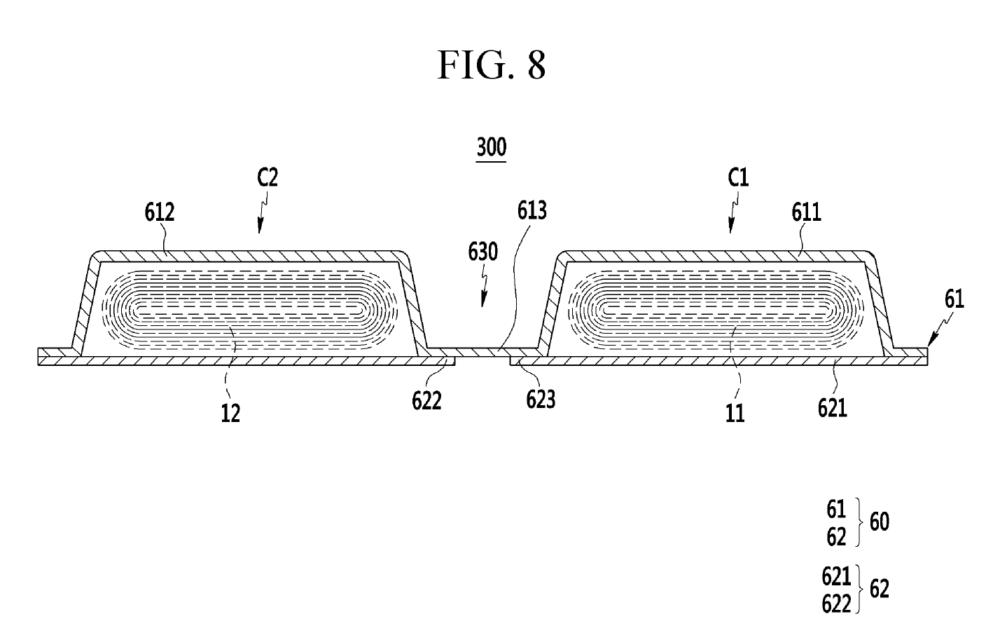

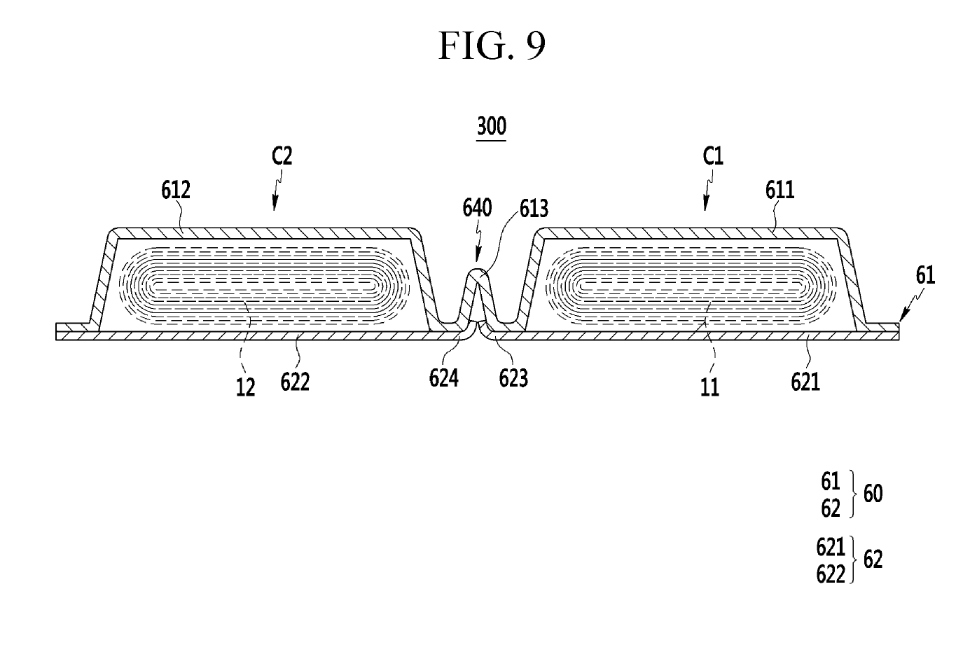

FIG. 8 is a cross-sectional view showing a rechargeable battery according to a third example embodiment, and FIG. 9 is a cross-sectional view showing a state where the rechargeable battery of FIG. 8 is folded. Referring to FIGS. 8 and 9, in a rechargeable battery 300 according to a third example embodiment, a pouch 60 includes a first sheet 61 to accommodate first and second electrode assemblies 11 and 12, and a second sheet 62 to cover the first and second electrode assemblies 11 and 12.

The first sheet 61 includes a first accommodating portion 611 opened from one side (lower side) in an axis direction (an upper and lower direction in FIG. 8) to accommodate the first electrode assembly 11, and a second accommodating portion 612 opened in the same direction as the first accommodating portion 611 to accommodate the second electrode assembly 12.

In this regard, the second sheet 62 includes a first portion 621 that covers the first electrode assembly 11 to be sealed by thermal bonding on the first sheet 61 corresponding to the first accommodating portion 611, and a second portion 622 that covers the second electrode assembly 12 to be sealed by thermal bonding on the first sheet 61 corresponding to the second accommodating portion 612.

The first sheet 61 accommodating a pair of electrode assemblies 11 and 12 is formed to be a single unit that is arranged with the first and second accommodating portion 611 and 612 opened from the one axis direction to the lower side and upper side. The second sheet 62 includes the first portion 621 and the second portion 622, each of which is formed in separate units. The second sheet 62 is disposed by corresponding to the first and second accommodating portion 611 and 612.

The sealing portion 630 and the folding portion 640 disposed between the one pair of battery cells C1 and C2 are formed with a connection portion 613 of the first sheet 61, and end portions 623 and 624 of first and second portions of the second sheet 621 and 622, respectively, sealed by thermal bonding to the inner side of the connection portion 613.

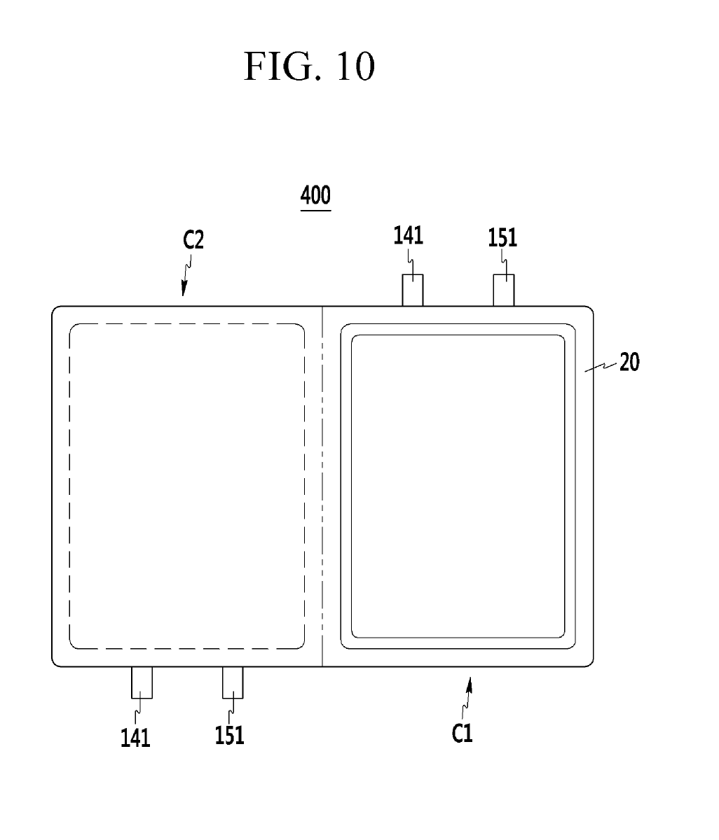

FIG. 10 is a top plan view showing a rechargeable battery according to a fourth example embodiment. Referring to FIG. 10, in a rechargeable battery 400 according to a fourth example embodiment, a positive electrode lead tab 141 connected to a positive electrode 14 and a negative electrode lead tab 151 connected to a negative electrode 15 are drawn out from a pair of battery cells C1 and C2 in the opposite side of the first and second electrode assemblies 11 and 12. The same draw directions of the positive and negative electrode lead tabs 141 and 151 as in the fourth example embodiment may be equally applied like as in the first example embodiment to the third example embodiment.

The rechargeable battery 400 in the fourth example embodiment may be used in conjunction with the rechargeable batteries 100, 200 and 300 to be configured as a rechargeable battery pack by connecting the batteries electrically.

While these embodiments have been described in connection with preferred embodiments, it is obvious that the embodiments are not limited to the preferred embodiments, but, on the contrary, is intended to conduct various modifications within the spirit and scope of the appended claims, the detailed description and the accompanying drawings and to belong to the range of the present embodiments.

What is claimed is:

1. A rechargeable battery comprising:
at least one pair of electrode assemblies comprising a first electrode assembly and a second electrode assembly; and
a pouch forming at least one pair of battery cells configured to accommodate the electrode assemblies and seal the outside of each electrode assembly,
wherein the pouch comprises a first sheet formed to be a single unit and configured to accommodate the at least one pair of electrode assemblies.

2. The rechargeable battery of claim 1, wherein the pouch includes a folding portion formed by folding a sealing portion between the one pair of battery cells.

3. The rechargeable battery of claim 2, wherein the pouch further comprises a second sheet configured to seal the first sheet to cover the at least one pair of electrode assemblies.

4. The rechargeable battery of claim 3, wherein the second sheet comprises a plurality of sheets.

5. The rechargeable battery of claim 3, wherein the first sheet and second sheets are sealed by heat welding or thermal bonding.

6. The rechargeable battery of claim 2, wherein the folding portion comprises an end portion of the second sheet attached to both sides of a connection portion of the first sheet disposed between the at least one pair of battery cells.

7. The rechargeable battery of claim 1, wherein the first sheet comprises a first accommodating portion on one side to accommodate the first electrode assembly and a second accommodating portion on the opposite side to accommodate the second electrode assembly.

8. The rechargeable battery of claim 7, wherein the second sheet comprises a first portion that covers the first electrode assembly and seals the portion of the first sheet corresponding to the first accommodating portion and a second portion that covers the second electrode assembly and seals the portion of the first sheet corresponding to the second accommodating portion.

9. The rechargeable battery of claim 8, wherein the first portion of the second sheet and second portion of the second sheet are sealed by heat welding or thermal bonding.

10. The rechargeable battery of claim 9, wherein the folding portion comprises an end portion of the first portion of the second sheet and an end portion of the second portion of the second sheet, which are attached on both sides of the connection portion of the first sheet disposed between the at least one pair of battery cells.

11. The rechargeable battery of claim 3, wherein the second sheet is formed to be a single unit, and
wherein the pouch comprises the portion of the first sheet that accommodates the first electrode assembly and covers the second electrode assembly, and the portion of the second sheet that accommodates the second electrode assembly and covers the first electrode assembly.

12. The rechargeable battery of claim 3, wherein the first sheet comprises a first accommodating portion open on one side to accommodate the first electrode assembly and a first cover portion to cover the second electrode assembly, and the second sheet comprises a second accommodating portion open on the opposite side to accommodate the second electrode assembly and a second cover portion to cover the first electrode assembly.

13. The rechargeable battery of claim 3, wherein the folding portion comprises the connection portion of the first sheet and the connection portion of the second sheet, which are disposed between the at least one pair of battery cells.

14. The rechargeable battery of claim 2, wherein the first sheet comprises a first accommodating portion open on one side to accommodate the first electrode assembly and a second accommodating portion open in the same direction to accommodate the second electrode assembly.

15. The rechargeable battery of claim 3, wherein the second sheet comprises a first portion that covers the portion of first electrode assembly to be sealed on the first sheet corresponding to the first accommodating portion and a second portion that covers the portion of the second electrode assembly to be sealed on the first sheet corresponding to the second accommodating portion.

16. The rechargeable battery of claim 15, wherein the folding portion comprises an end portion of the first portion of the second sheet and an end portion of the second portion of the second sheet, which are attached on both sides of the connection portion of the first sheet disposed between the at least one pair of battery cells.

17. The rechargeable battery of claim 1, comprising a first lead tab connected to the first electrode assembly and a second lead tab connected to the second electrode assembly, both extending from each battery cell in substantially the same direction.

18. The rechargeable battery of claim 1, comprising a first lead tab connected to the first electrode assembly and a second lead tab connected to the second electrode assembly extending from each battery cell in substantially opposite directions from each other.

19. A pouch for a rechargeable battery comprising:
at least one pair of battery cells configured to accommodate electrode assemblies and seal the outside of each electrode assembly,
wherein the pouch comprises a first sheet formed to be a single unit and configured to accommodate at least one pair of electrode assemblies.

20. The pouch of claim 19, further comprising a second sheet configured to seal the first sheet to cover the electrode assembly.
